(19) United States
(12) Patent Application Publication
(10) Pub. No.: US 2006/0007182 A1
(43) Pub. Date: Jan. 12, 2006

(54) Information-processing apparatus and programs used therein

(75) Inventors: Takashi Sato, Tokyo (JP); Hiroki Tamai, Kanagawa (JP); Takanori Nishimura, Kanagawa (JP)

Correspondence Address: FROMMER LAWRENCE & HAUG LLP, 745 Fifth Avenue, New York, NY, 10151, US

(73) Assignee: Sony Corporation, Tokyo (JP)

(21) Appl. No.: 11/175,473

(22) Filed: Jul. 6, 2005

(30) Foreign Application Priority Data
Jul. 8, 2004 (JP) P2004-202349

(51) Int. Cl. G09G 5/00

(52) U.S. Cl. 345/173

(57) ABSTRACT

In an information-processing apparatus employing a coordinate input unit such as a touch panel, processing of explicitly reporting the state of an operation carried out by the user to the user is carried out in order to present a result of the operation to the user. In the information-processing apparatus employing the coordinate input unit and a display unit integrated with the coordinate input unit, in accordance with the type of an operation carried out by the user on the coordinate input unit, the apparatus issues a notice for verifying the state of the operation as well as a result of the operation and avoiding an incorrect operation to the user. To put it concretely, in the configuration of the information-processing apparatus, by outputting a display detectable by the visual sense, a sound or a vibration pattern in accordance with the number of times contact with the coordinate input unit has been made during an operation or in accordance with the state of sustaining such contact, it is possible to verify whether a tap operation or a drag operation has been carried out as intended by the user.

### BACKGROUND OF THE INVENTION

The present invention relates to a technology for enhancing the operatability of an information-processing apparatus, which allows the user to enter operation inputs while viewing a screen display by carrying out an operation on a coordinate input unit (or a coordinate read unit) such as a touch panel, by letting the user verify a result of the operation to enter the operation input and using means of the visual sense, the auditory sense or the tactile sense as means for presenting a message indicating an erroneous input and/or an erroneous operation and asking the user to take caution against erroneous inputs as well as erroneous operations.

In the case of an information-processing apparatus receiving operation inputs as is the case with a computer, for example, a configuration including an operation screen implemented by a software keyboard is known. An example of the operation screen is a virtual keyboard.

In a configuration including a coordinate input unit such as a touch panel or a tablet, for example, an application is executed under an operating system running in the information-processing apparatus, and the user is allowed to operate the apparatus by using a graphical user interface while viewing information displayed on the screen. The operating system is abbreviated hereafter to the OS.

In order to reduce the number of drag-operation mistakes in an electronic apparatus employing a coordinate input unit, it is possible to adopt a known method of controlling determination as to whether or not to display an operation command item in accordance with an operation carried out by the user. A drag operation is an operation carried out by touching an operation face with a finger, a pen or the like, moving the finger, the pen or the like over the operation face while maintaining the state of contact of the finger, the pen or the like with the operation face to a desired destination position and releasing the finger, the pen or the like from the state of contact of the finger, the pen or the like with the operation face. For details of the method, refer to documents such as Japanese Patent Laid-open No. 2004-48229.

### SUMMARY OF THE INVENTION

In the case of a drag operation, however, the related information-processing apparatus merely carries out processing to inform the user that a finger, a pen, a stylus or the like has been brought into contact with the operation face by providing the user with information independent of the type of the drag operation. That is to say, the conventional information-processing apparatus has a problem that the apparatus is not provided with sufficient means for allowing the user to recognize an operation result by itself and reduce the number of operation mistakes or the like.

In the case of an apparatus such as a computer employing a touch panel, for example, the following problems are raised.

An operation to touch an operation face inadvertently is mistakenly interpreted as an operation to enter an input.

When the user carries out a time-wise continuous operation such as a double-tap operation, the user is not capable of immediately knowing whether the operation has been actually successful.

If a parallax error is generated due to a positional relation between the visual point of the user and the tip of a finger, the tip of a pen or the like, causing a positional shift in the entered command, a correct operation for the command cannot be carried out.

If the tip of a finger, the tip of a pen or the like may be released inadvertently from the state of being in contact with the operation face in the course of a drag operation, the user is not aware of the fact that the drag operation is completed unintentionally.

In order to solve the problems described above, the inventors of the present invention have devised an information-processing apparatus employing a coordinate input unit as an apparatus capable of carrying out processing to explicitly inform the user of a state of an operation carried out by the user and present a result of the operation to the user.

In order to solve the problems described above, in accordance with an embodiment of the present invention, there is provided an information-processing apparatus capable of giving the user a notification for allowing the user to verify the state of an operation carried out on a coordinate input unit employed in the apparatus and confirm a result of the operation as well as prevent the user from carrying out an incorrect operation as a notification depending on the type of the operation.

In addition, in accordance with another embodiment of the present invention, there is also provided a program to be executed by the information-processing apparatus as a program including a step of giving the user a notification for allowing the user to verify the state of an operation carried out on the coordinate input unit employed in the apparatus and confirm a result of the operation as well as prevent the user from carrying out an incorrect operation as a notification depending on the type of the operation.

Thus, in accordance with the present invention, by virtue of the notification according to the type of an operation carried out on the coordinate input unit, the user itself is capable of verifying the state of an operation and confirming a result of the operation as well as quickly knowing that an incorrect or inadvertent operation has been carried out.

In accordance with the present invention, the user is explicitly informed of the state of an operation carried out by the user so that a result of the operation can be presented to the user and the user can be asked to take caution against an erroneous inputs as well as an erroneous operation. As a result, it is possible to enhance the operatability of the information-processing apparatus and reduce the number of operation mistakes or the like.

In addition, by giving the user a display detectable by the visual sense as a display depending on the type of an operation carried out by the user on the coordinate input unit, a result of the operation can be reflected immediately in the display appearing on the screen.

On top of that, in a configuration including an audio output section, sounds generated in operations are not output uniformly. Instead, a sound is output in dependence on the type of an operation carried out on the coordinate input unit in order to present a result of the operation or other information to the user. As a result, since the user is capable of knowing a response given by the information-processing apparatus as a response to be sensed by the auditory sense of the user in accordance with the type of an operation carried out on the coordinate input unit, this sound generation feature is convenience for the user.

In a configuration including a vibration generation section, vibration depending on the type of an operation carried out by the user on the coordinate input unit is generated to notify the user of a result of the operation or other information. Thus, without relying on the visual and auditory senses, the user is capable of knowing a response given by the information-processing apparatus in accordance with the type of an operation carried out on the coordinate input unit. This vibration generation feature is effective for applications in a condition wherein sound generation is to be waived or in a noisy environment.

In addition, by outputting or modifying a display detectable by the visual sense, a sound or a vibration pattern in accordance with the number of contacts with the coordinate input unit or in accordance with the sustenance of the contact state, a variety of responses according to a variety of operations can be presented to the user.

### BRIEF DESCRIPTION OF THE DRAWINGS

FIG. 1 is a diagram showing a typical basic configuration of the present invention;

FIGS. 2A to 2C are variety of conceptual explanatory diagrams showing a variety of operations;

FIG. 3 shows a flowchart representing processing to issue a notice according to an operation;

FIG. 4 is a diagram to be referred to in description of embodiments provided by the present invention in conjunction with FIGS. 5 to 10 as an explanatory diagram showing a perspective view of a typical external appearance of an information-processing apparatus according to an embodiment of the present invention;

FIG. 5 is a diagram a typical hardware configuration of the information-processing apparatus;

FIG. 6 is a conceptual diagram showing principal elements of a configuration of software related to operation processing;

FIG. 7 shows a flowchart representing typical display processing;

FIGS. 8A to 8D are variety of explanatory diagrams showing a typical single-tap operation and a typical double-tap operation;

FIGS. 9A to 9D are variety of explanatory diagrams showing a typical drag operation; and

FIG. 10 is an explanatory diagram showing a case in which a release operation is inadvertently carried out in the course of a drag operation.

### DETAILED DESCRIPTION OF THE PREFERRED EMBODIMENTS

The present invention provides an information-processing apparatus employing a coordinate input unit with a configuration for feeding back the state of an operation carried out by the user on the coordinate input unit to the user. It is to be noted that the information-processing apparatus according to an embodiment of the present invention can be applied to an apparatus having a touch panel or the like. Examples of such an apparatus are a computer, a PDA (Personal Digital Assistance), a variety of video apparatus and a variety of audio apparatus.

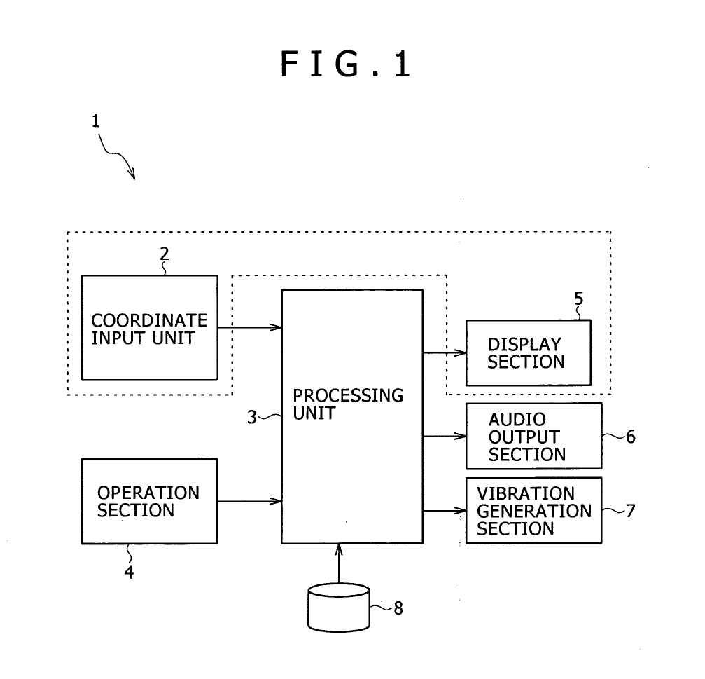

FIG. 1 is a conceptual diagram showing a typical basic configuration of an information-processing apparatus 1 according to an embodiment of the present invention.

Information on an operation carried out on a coordinate input unit 2 is supplied to a processing section 3 including typically a CPU (Central Processing Unit) or a system controller.

It is to be noted that the coordinate input unit 2 includes a touch panel integrated with a display section 5 to be described later, a pen-input device and a digitizer. If the user specifies a position on an operation face by pointing a finger, a pen, a stylus or the like to the position, for example, the absolute coordinates of the position are detected.

Information on an operation carried out on an operation section 4 having operation buttons and switches is processed by the processing section 3. However, the present invention can of course be applied to a configuration not including such an operation section 4.

As a display section 5 integrated with the coordinate input unit 2, a device such as a liquid-crystal display panel is employed. The display section 5 is used for displaying various kinds of display information such as a key top layout and screen information. For example, the user can enter a select input such as a character or a symbol by operating the coordinate input unit 2 while viewing a screen display.

The information-processing apparatus 1 carries out notification processing allowing the user to verify the state of an operation carried out on the coordinate input unit 2 and confirm a result of the operation in dependence on the type of the operation. In addition, the information-processing apparatus 1 also carries out notification processing to prevent an erroneous operation and an incorrect input. The notification processing is carried out in the following implementations. (1) Notification using a display detectable by the visual sense. (2) Notification using an audio output detectable by the auditory sense. (3) Notification using generated vibration detectable by the tactile sense. (4) A combination of any of implementations (1) to (3).

First of all, in implementation (1) of the notification, a display that can be detected by the visual sense as a display according to an operation carried out on the coordinate input unit 2 includes a display element appearing on the display section 5. Examples of the display element are a mark, an icon, a cursor and a figure. The user then looks at the display to confirm the operation carried out by the user itself and can thus be aware of an erroneous operation and information on the erroneous operation such as the cause of the erroneous operation.

In addition, in implementation (2) of the notification, the information-processing apparatus 1 has a configuration including an audio output section 6 such as a speaker. In such a configuration, the audio output section 6 outputs a sound such as a beep sound in accordance with an operation carried out on the coordinate input unit 2 as a notification given to the user. For example, in accordance with the number of operation contacts with the coordinate input unit 2, the state of sustenance of an operation contact with the coordinate input unit 2 or the duration of such a contact, a parameter of sound generation is changed so as to urge the user to pay attention to the generated sound. Examples of the parameter include the tone of the sound, the frequency of the sound and the number of times the sound is generated. By listening to the generated sound, the user is capable of confirming the operation carried out by the user itself and can thus be aware of an erroneous operation and information on the erroneous operation such as the cause of the an erroneous operation. In the case of surroundings with bright illumination or the like, for example, the user is capable of confirming the operation carried out by the user itself without relying on the visual sense.

In implementation (3) of the notification, the information-processing apparatus has a configuration including a vibration generation section 7 such as a vibration motor. In such a configuration, the vibration generation section 7 generates vibration in accordance with an operation carried out on the coordinate input unit 2 as a notification given to the user. For example, in accordance with the number of operation contacts with the coordinate input unit 2, the state of sustenance of an operation contact with the coordinate input unit 2 or the duration of such a contact, a vibration parameter is changed so as to urge the user to pay attention to the generated sound. Examples of the vibration parameter are the frequency of the vibration, the number of times the vibration is generated and the vibration pattern. The user is therefore capable of confirming the operation carried out by the user itself and can thus be aware of an erroneous operation and information on the erroneous operation such as the cause of the an erroneous operation. As a result, the user is capable of confirming the operation carried out by the user itself without relying on the visual sense and the auditory sense.

Implementations (1) to (3) of the notification can be realized individually. However, the user is also allowed to select any one of the implementations. As another alternative, any of them can be combined in accordance with necessity.

As described above, the present invention allows a variety of notifications detectable by the visual sense, the auditory sense and/or tactile to be given to the user in accordance with the type of an operation carried out on the coordinate input unit. In the case of a system configuration in which the display unit and the absolute-coordinate input unit such as a touch panel are integrated with each other, examples of the operations carried out by the user are given as follows.

A touch operation is an operation to bring the tip of a finger, the tip of a stylus or the like into contact with a touch panel and keep the tip of the finger, the tip of the stylus or the like in a state of being in contact with the panel as it is. The touch operation corresponds to an operation to press a left button in a mouse operation for ordinary setting of the touch panel in a Microsoft OS or the like.

A release operation is an operation to release the finger, the stylus or the like from the state of being in contact with the touch panel. The release operation corresponds to an operation to release the left button in the mouse operation cited above.

A single-tap operation (or a tap operation) is an operation to bring the tip of a finger, the tip of a stylus or the like into contact with the touch panel and immediately take away the finger, the stylus or the like from the panel. The single-tap operation (or the tap operation) corresponds to an operation to click the left button in the mouse operation cited above.

A double-tap operation is an operation to carry out the single-tap operation (or the tap operation) twice in a row. The double-tap (tap) operation corresponds to an operation to a double-click operation carried out on the left button in the mouse operation cited above.

A drag operation is an operation to move the tip of a finger, the tip of a stylus or the like on the touch panel by keeping the tip of the finger, the tip of the stylus or the like in a state of being in contact with the panel. The drag operation corresponds to a drag operation carried out on the left button in the mouse operation cited above.

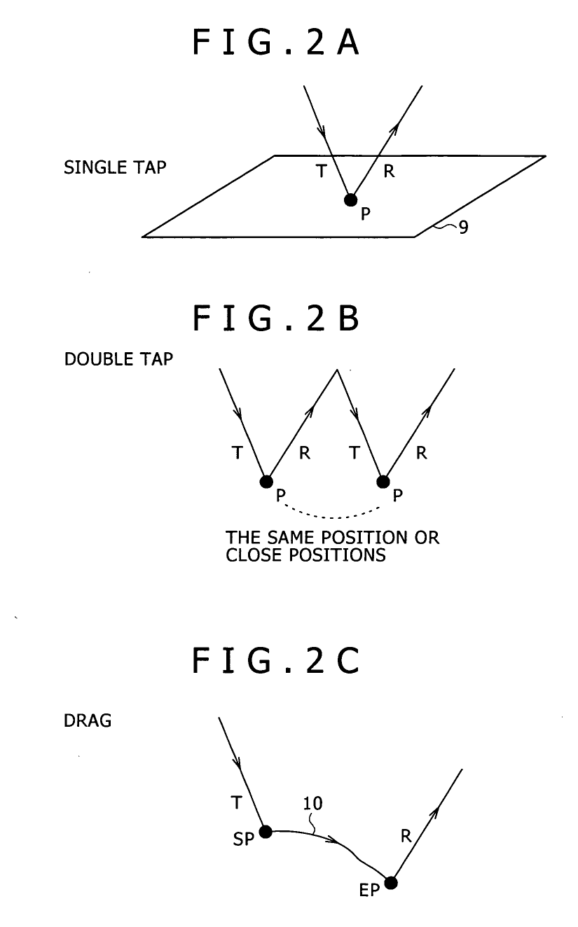

FIGS. 2A to 2C are explanatory conceptual diagrams referred to in description of the single-tap, double-tap and drag operations. Points P, SP and EP shown in the figure are each a point of contact on an operation face 9 of the coordinate input unit 2. Symbol T on the wing of an arrow pointing to any point of contact implies a touch operation. On the other hand, symbol R on the wing of an arrow pointing to in a direction departing from any point of contact implies a release operation. Points SP and EP denote respectively the start and end points of a drag operation.

As shown in FIG. 2A, in a single-tap operation, the tip of a finger, the tip of a stylus or the like is brought into contact with a touch panel and then immediately taken away from the panel. As shown in FIG. 2B, in a double-tap operation, the single-tap operation is carried out twice in a row within a predetermined period of time on the same point or two points separated away from each other by a predetermined distance. As shown in FIG. 2C, after the tip of a finger, the tip of a stylus or the like is brought into contact with point SP on a touch panel, the tip of the finger, the tip of the stylus or the like is moved along a locus 10 with the finger, the stylus or the like kept in a state of being in contact with the panel before the tip of the finger, the tip of the stylus or the like is released from the state at point EP.

A program including a step of issuing a notice for verifying the state of an operation carried out by the user or a result of the operation or preventing an incorrect operation in accordance with the type of the operation is loaded from a storage section 8 employed in the information-processing apparatus 1 shown in FIG. 1 and interpreted by a CPU for the purpose of execution. That is to say, the main substance of processing carried out by the information-processing apparatus 1 necessitates hardware including a processing section such as the CPU and a variety of whole programs to be executed by the processing section. To put it concretely, predetermined processing is carried out by execution of a program corresponding to information provided by an operation carried out by the user.

A program according to an embodiment of the present invention includes the following processing steps. (a) A step of detecting the fact that an operation has been carried out by the user on the coordinate input unit. (b) A step of issuing a notice to the user in accordance with the number of times contact with the coordinate input unit has been made and the state of sustaining such contact in an operation carried out by the user on the coordinate input unit at step (a).

First of all, at step (a), detection processing is carried out to determine whether or not the user has carried out an operation on the coordinate input unit 2. Then, at step (b), notification processing is carried out to issue a notice detectable by the visual sense, the auditory sense or the tactile sense in dependence on the type of the operation. In implementation (1) of the notification, for example, a display determined in accordance with the state of the operation as a display detectable by the visual sense is output or changed. The operation to change the display includes an operation to modify the color and/or shape of the display. In implementation (2) of the notification, a sound according to the state of the operation is output or changed. The operation to change the sound includes an operation to modify the tone of the sound, the frequency of the sound and/or the number of times the sound is output. In implementation (3) of the notification, vibration according to the state of the operation is generated or changed. The operation to change the vibration includes an operation to modify the frequency of the vibration, the number of times the vibration is generated and/or the vibration pattern.

By application of the information-processing apparatus according to an embodiment of the present invention, a program to be executed by the apparatus and a recording medium for recording such a program, it is possible to implement a system for feeding back a result of an operation carried out by the user on a touch panel or a result obtained from an input entered by the user to the user in order to take countermeasures describes as follows.

Countermeasure for preventing an inadvertent touch operation from being interpreted as a normal input

A display, which can be detected by the visual sense as a display provided for a single-tap operation, is sustained for a predetermined period of time or a period set in advance. As an alternative, during a single-tap operation, for a predetermined period of time or a period set in advance, a specific sound is output or a specific vibration pattern is generated.

When the user enters an input deliberately by using a stylus and the hand holding the stylus inadvertently comes in contact with the touch panel before the stylus does, for example, an input due to the contact made mistakenly by the hand is recognized and the user may not be aware of the recognition of the input inadvertently entered by the user in some cases. However, such a problem can be solved by issuance of a notification provided for a single-tap operation. For example, seeing a display detectable by the visual sense, the user is capable of knowing which position has been pressed before the tip of the stylus comes in contact with the touch panel.

Countermeasure for preventing the user from being incapable of actually confirming a double-tap operation carried out by the user

A display, which can be detected by the visual sense as a display provided for a double-tap operation, is sustained for a predetermined period of time or a period set in advance. As an alternative, during a double-tap operation, for a predetermined period of time or a period set in advance, a specific sound is output or a specific vibration pattern is generated.

In order to carry out a double-tap operation, it is necessary to perform a single-tap (tap) operation twice in a row on positions separated away from each other by a predetermined distance and within a predetermined period of time. In some cases, the user is not capable of knowing whether or not the double-tap operation carried out by the user itself satisfies these conditions and, hence, whether or not the information-processing apparatus has recognized the double-tap operation correctly. However, such a problem can be solved by issuance of a notification provided for a double-tap operation. For example, seeing a display detectable by the visual sense after the double-tap operation, the user is capable of determining whether or not the double-tap operation has been carried out correctly.

Countermeasure for solving a problem caused by an error generated in the course of an operation carried out to enter an input by bringing the tip of a finger, the tip of a stylus or the like into contact with a touch panel as a parallax error attributed to a positional relation between the visual point of the user and the tip of the finger, the tip of the stylus or the like.

The display is changed to a display detectable by the visual sense making a parallax error difficult to generate. An example of such a display is a pointer icon. As an alternative, a specific sound is output or a specific vibration pattern is generated in place of the display detectable by the visual sense.

In a drag operation carried out on a touch panel by using a stylus, for example, due to a parallax error, the user may terminate the drag operation at a location different from the intended position in some cases. This problem can be solved by changing the display detectable by the visual sense in the course of the drag operation in order to reduce the effect of the parallax error.

Countermeasure for preventing a drag operation carried out by the user by moving the tip of a finger or the tip of a stylus on a touch panel from being ended at a position not intended by the user due to the fact that the tip of the finger or the tip of the stylus is released inadvertently from the state of being in contact with the touch panel.

A display detectable by the visual sense is sustained for a predetermined period of time or a period set in advance. As an alternative, in place of a display detectable by the visual sense, a specific sound is output or a specific vibration pattern is generated.

When the user inadvertently releases the tip of a stylus from the state of being in contact with a touch panel, that is, when the user mistakenly removes the tip of the stylus away from the surface of the touch panel only instantaneously, in the course of a drag operation carried out by the user on the touch panel by moving the tip of the stylus, for example, the inadvertent movement of the stylus is recognized as a release at the point of time the tip of the stylus departs from the surface of the touch panel. In this case, however, the user may not be aware of the fact that the inadvertent movement of the stylus has been recognized mistakenly as a release operation, raising a problem. Such a problem can be solved by explicitly issuing a notice revealing the end of a drag operation.

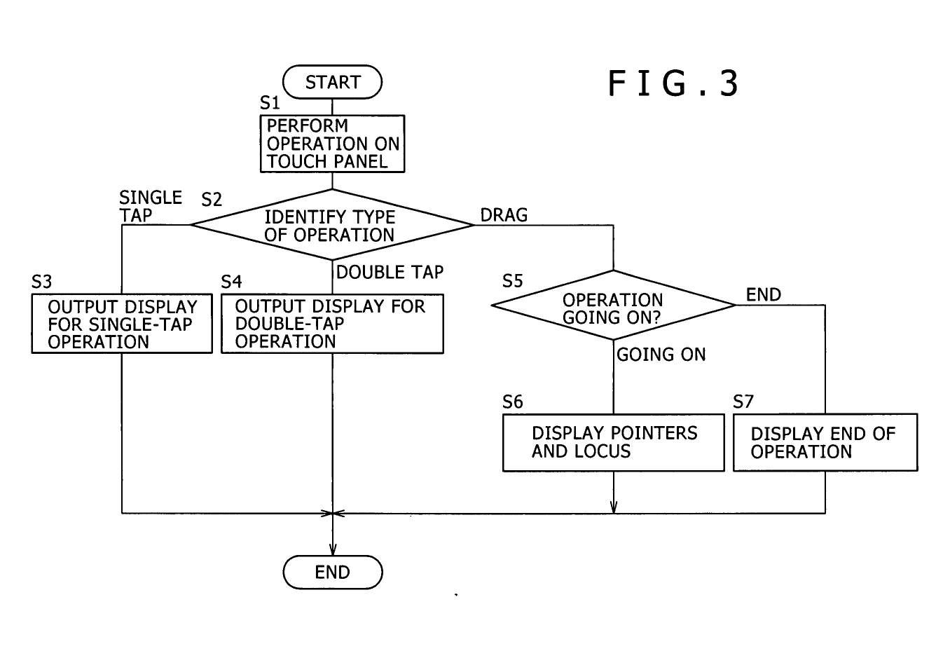

FIG. 3 shows a flowchart representing processing to issue a notice according to an operation carried out by the user on a touch panel for implementation (1) of the notification in an input unit employing the touch panel.

As shown in the figure, the flowchart begins with a step S1 at which an operation carried out by the user on the touch panel by using a finger, a stylus or the like is detected. Then, at the next step S2, the type of the operation is determined. If the operation is a tap and release operation carried out once, the flow of the processing goes on to a step S3 at which a display such as a mark or an icon for the single-tap operation is output for a predetermined period of time. If the operation is a double-tap operation, the flow of the processing goes on to a step S4 at which a display for the double-tap operation is output for a predetermined period of time.

If the operation is a drag operation, the flow of the processing goes on to a step S5 to determine whether the drag operation is still being carried out or has been ended. If the drag operation is still being carried out, the flow of the processing goes on to a step S6 at which a specific pointer display is output or a locus representing a change accompanying the slide operation as the change of the contact position is displayed. If the drag operation has been ended, on the other hand, the flow of the processing goes on to a step S7 at which a display revealing the end of the drag operation is output for a predetermined period of time.

As described above, a notice according to the type of an operation is issued to immediately feed back information such as a result of the operation to the user. Such information will contribute to reduction of the number of operation mistakes or operations carried inadvertently.

It is to be noted that the operation to display or output a notice according to the type of an operation can be carried out in accordance with any one of configuration implementations described as follows.

Configuration implementation in which information such as the type of a visually sensible display, sound or vibration pattern associated with an operation and/or a setting time is set in advance.

Configuration implementation in which the user is allowed to arbitrarily select a display detectable by the visual sense, a sound or a vibration pattern or change information such as a set time. This configuration implementation is thus an implementation customizable by the user.

### Embodiments

An embodiment applying the present invention to a portable computer is explained as follows.

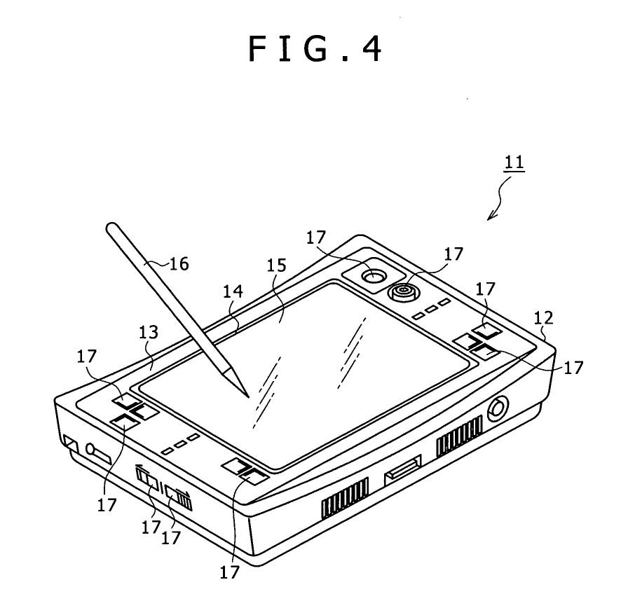

As shown in FIG. 4, a case 12 of an information-processing apparatus 11 is a flat rectangle having horizontal sides longer than the vertical sides. A display device 14 serving as a picture display section is provided on the front face 13 of the information-processing apparatus 11. The display device 14 is typically a liquid-crystal display device.

On the surface 15 of the display device 14, a touch panel is provided. The user is capable of carrying out a select operation, an input operation or another operation by pointing a finger or a pen 16 such as a stylus to a desired position on an operation face while viewing a display screen. It is to be noted that, at predetermined locations on the case 12, a variety of operation elements 17, 17 and so on are provided. The operation elements 17, 17 and so on include buttons, switches and an operation stick.

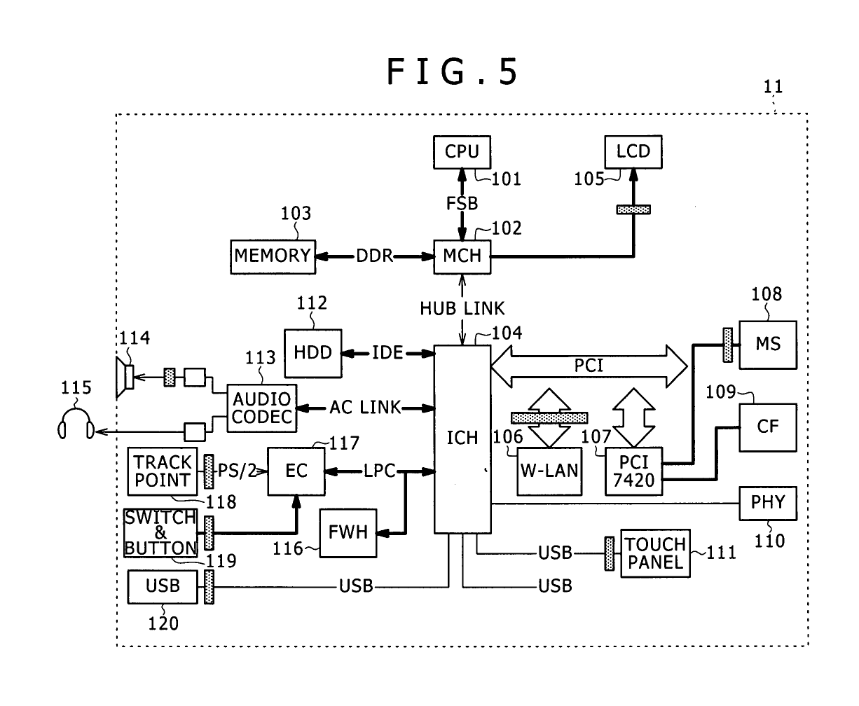

FIG. 5 is a diagram of a typical hardware configuration of the information-processing apparatus 11.

A CPU 101 serving as a control core is connected to a control unit 102 by an FSB (Front Side Bus). The control unit 102 forms the processing section 3 cited earlier in conjunction with a control unit and a device, which will be described later. The control unit 102 is a section in charge of control of a main memory 103 and control related to a graphical function. The control unit 102 plays a role of mainly processing data of a large amount at a high speed. In an AT-compatible apparatus, the control unit 102 is referred to as a north bridge. The control unit 102 is connected to the CPU 101, the main memory 103, a control unit 104 and a graphic display unit 105 serving as the display section 5 mentioned earlier. Typically, the graphic display unit 105 is also a liquid-crystal display unit.

The control unit 104 is a section for mainly controlling, among others, a control device provided for a user interface. The control unit 104 also carries out other operations such as bus linking of devices. In an AT-compatible apparatus, the control unit 104 is referred to as a south bridge. As a PCI to ISA bridge, the control unit 104 plays the role of a bridge between a PCI (Peripheral Component Interconnect) bus and a low-speed ISA (Industry Standard Architecture) bus. The control unit 104 has functions of controllers such as an ISA controller and an IDE (Integrated Drive Electronics) controller.

The PCI bus is connected to a radio communication device 106 for connection to a radio LAN (W-LAN) and a device 107 for connection to (and controlling) an external apparatus and an external memory. The external memory is a semiconductor memory device, which can be mounted onto and demounted from the main body of the information-processing apparatus 11. Typically, for the external memory, the device 107 is connected to a control device 108 for reading out and writing data from and into a stick storage medium. The device 107 is also typically connected to a control device 109 for controlling a card storage medium. In addition, the device 107 has functions of an interface for connection to the external apparatus. Typically, the interface conforms to IEEE1394 specifications of hardware for adding a serial device to a computer.

The control unit 104 is connected to a LAN (Local Area Network) connection device 110 and a touch panel 111 corresponding to the coordinate input unit 2 mentioned before through a USB (Universal Serial Bus) port.

An auxiliary storage unit 112 is connected to the IDE controller in the control unit 104. As the auxiliary storage unit 112, a drive for a magnetic disk or an optical disk is typically employed. In this embodiment, however, a drive for a large-capacity storage medium such as a hard disk is employed.

An audio-signal-processing section (an audio codec) 113 connected to the control unit 104 supplies an audio signal to typically a speaker 114 or a headphone 115 in order to generate a sound. The audio signal is a signal obtained as a result of a digital/analog conversion process. As described before, a sound according to the type of an operation is generated so as to allow the user to confirm a result of the operation in implementation (2) of the notification. As an alternative, in the case of an information-processing apparatus employing a microphone, an audio-signal-processing section 113 carries out a process to convert the analog input signal into digital data.

A storage unit 116 is a memory used for storing information such as control programs for controlling the computer. The storage unit 116 is connected to the control units 104 and 117 through an LPC (Low Pin Count) serial bus.

The control unit 117 is a general-purpose control unit for controlling a variety of signals. As the control unit 117, for example, an EC (embedded controller) is employed. The control unit 117 executes control such as control of functions of a keyboard controller, control of the power supply of the system and control of additional functions of the system. The control unit 117 typically includes a microcomputer in the case of a portable information-processing apparatus. It is to be noted that, by modifying a control program in the storage unit 116, the method of controlling the computer can be changed.

An operation device 118 serving as a stick-type pointing device such as a track pointer is connected to a port of the control unit 117. An example of the port is a port of the PS/2 (Personal System/2). In addition, a signal from an operation section 119 including a plurality of operation elements provided on the main body of the information-processing apparatus 11 is supplied to the control unit 117. As a connection section 120 for directly connecting the external apparatus to the main body of the information-processing apparatus 11, a USB connector is employed. This connector is linked to the control unit 104.

It is to be noted that the voltage of the commercial power supply is supplied to a power-supply section not shown in the figure through an AC adapter. As an alternative, the power-supply section may receive power from a battery pack having a secondary battery or a fuel battery.

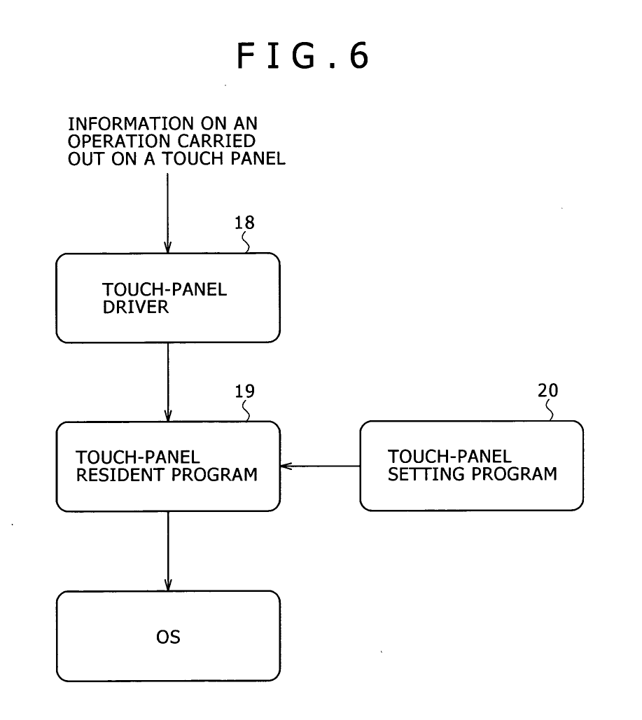

FIG. 6 is a conceptual diagram showing principal elements of a configuration of software related to operation processing carried out on the touch panel 111.

After information on an operation carried out on the touch panel 111 is output to the control unit 104, the information is supplied to a resident program 19 by way of the touch-panel driver 18. The resident program 19 is a program to be executed to carry out, among others, notification processing according to the state of an operation carried out on the touch panel 111. The resident program 19 delivers an operation message to the OS on an upper-level layer. Receiving the message, information on an operation is transferred from the OS to an application not shown in the figure to request the application to carry out predetermined processing.

The resident program 19 refers to information set by a setting program 20 as information on the touch panel 111, presenting a reaction according to the type and state of the operation to the user. Let us keep in mind that it is possible to provide an embodiment including some or all functions of the resident program 19 in the touch-panel driver 18.

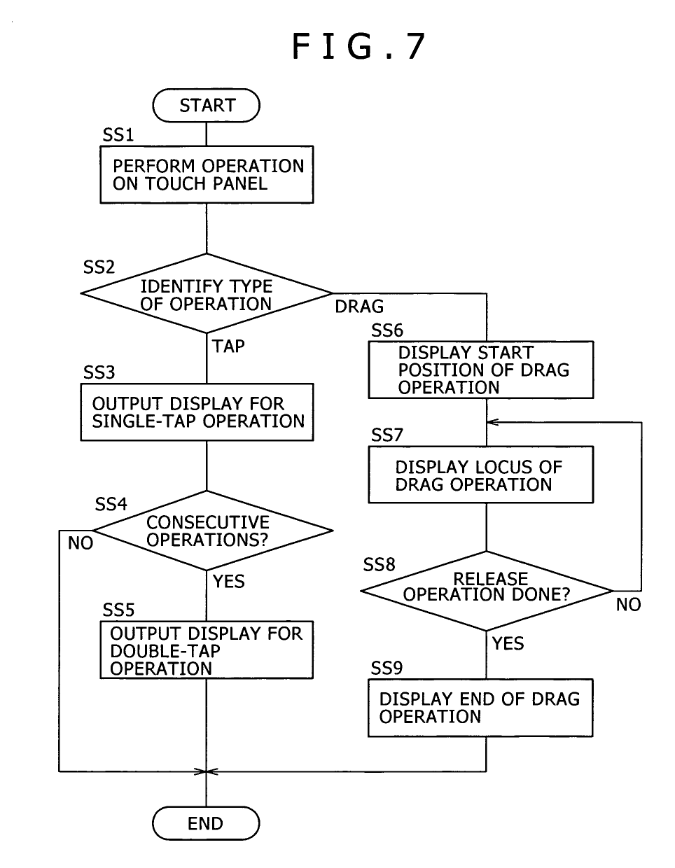

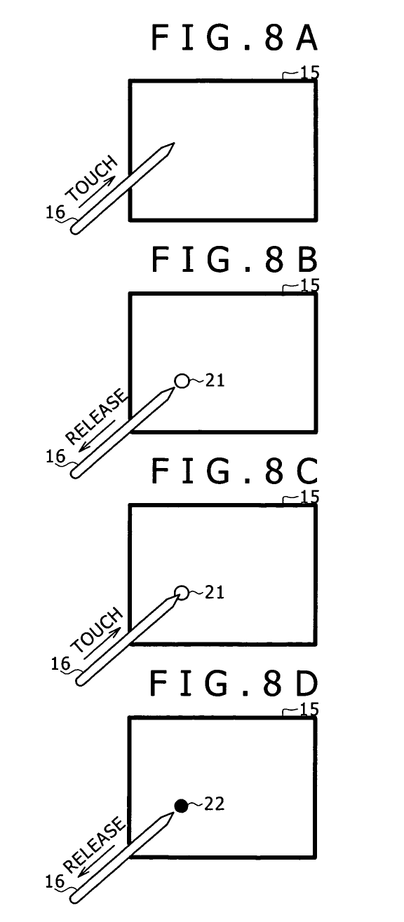

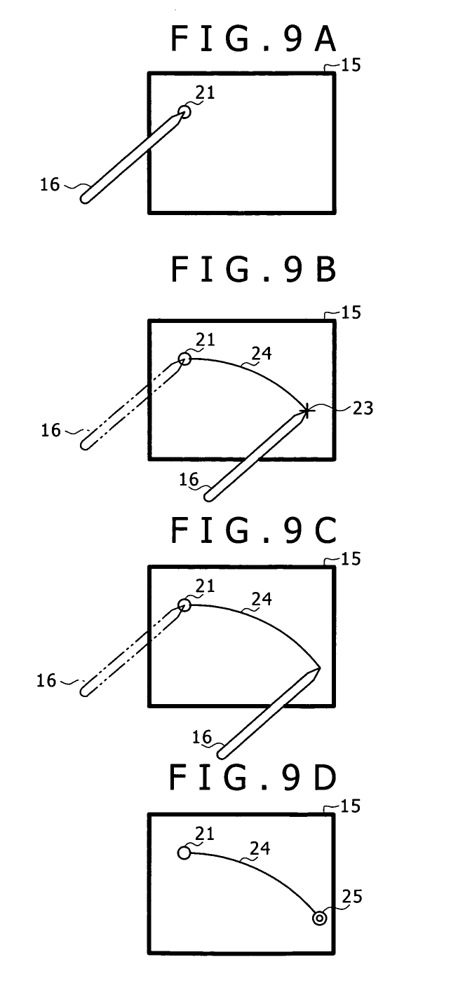

FIG. 7 shows a flowchart representing typical processing carried out by execution of the resident program 19. FIG. 8 is an explanatory diagram showing typical displays appearing during single-tap and doubles-tap operations. FIG. 9 is an explanatory diagram showing typical displays appearing during a drag operation. It is to be noted that examples explained below are examples for implementation (1) of the notification.

The flowchart shown in FIG. 7 begins with a step SS1 at which the user carries out an operation on the touch panel 111. Then, at the next step SS2, the operation carried out by the user is examined to determine whether the operation is a tap operation or a drag operation.

First of all, steps SS3 to SS5 of the flowchart shown in FIG. 7 are explained by referring to FIG. 8 as steps, which are executed for a tap operation in case the operation is determined to be a tap operation.

At the step SS3, a display for a single-tap operation is output. Examples of the display for a single-tap operation are an icon and a mark. That is to say, as shown in FIG. 8A, when the user taps the operation face of the touch panel 111 for the first time, the operation to tap the face is recognized as a single-tap operation. As a result, as shown in FIG. 8B, a display element 21 for a single-tap operation is output, being displayed for a predetermined period of time. In this example, the display element 21 is shown as a circle of the white color.

Then, the flow of the processing goes on to the next step SS4 to determine whether or not the tap operation has been carried out by the user twice in a row within a predetermined period of time and on positions separated away from each other by a predetermined distance. If the result of the determination indicates that the tap operation has been carried out by the user twice in a row within a predetermined period of time and on positions separated away from each other by a predetermined distance, the operation is recognized as a double-tap operation. In this case, the flow of the processing goes on to a step SS5 at which the screen is switched to a display for a double-tap operation. That is to say, if the user again taps the operation face of the touch panel 111 as shown in FIG. 8C, the operations carried out by the user are recognized as a double-tap operation. As a result, as shown in FIG. 8D, a display element 22 for a double-tap operation is output, being displayed for a predetermined-period of time. In this example, the display element 22 is shown as a circle of the black color. It is to be noted that, in place of a method of changing the color of a display element as is the case with this example, it is possible to adopt another method such as a technique to change another attribute of the display element or a technique to show a display element as a blinking display for distinguishing the element from the other. Examples of the other attribute of the display element are the shape and size of the element.

In this way, when an operation to enter an input via the touch panel 111 is recognized as a single-tap operation, at the specified position, which is the contact position, a display element 21 for a single-tap operation is output, being displayed for a predetermined period of time. This processing allows the user to be explicitly informed that the user has inadvertently touched the touch panel 111 and the inadvertent operation carried out by the user has been mistakenly interpreted as an input.

In addition, if the tap operation has been carried out by the user twice in a row within a predetermined period of time and on positions separated away from each other by a predetermined distance and the operation is thus recognized as a double-tap operation, the screen is switched to a display for a double-tap operation and sustains the display for a double-tap operation for a predetermined period of time. This processing allows the user to look at an explicit display indicating whether or not a double-tap operation deliberately carried out by the user has been actually recognized as a double-tap operation in a correct manner.

Next, steps SS6 to SS9 of the flowchart shown in FIG. 7 are explained by referring to FIG. 9 as steps, which are executed for a drag operation in case the operation is determined to be a drag operation at the step SS2.

At the step SS6, the start position of the drag operation is displayed as an icon, a mark or the like. For example, a display for a single-tap operation is shown at the start position on the screen. To put it concretely, when the user touches the operation face of the touch panel 111 to start a drag operation, a display element 21 appears as shown in FIG. 9A. In this example, the display element 21 is shown as a circle of the white color.

Then, at the next step SS7, the display element moving along a locus 24 of the position of contact of the moving stylus or the like with the operation face during the drag operation changes to a display element 23 used specially for a drag operation. In this example, the display element 23 is displayed as a +mark. That is to say, in the example shown in FIG. 9B, the display element 23 having a shape different from that of the display element 21 appearing at the start point appears and the locus 24 of the drag operation is also shown as well.

Then, the flow of the processing represented by the flowchart shown in FIG. 7 goes on to a step SS8 to determine whether or not a release operation has been carried out. If a release operation has been carried out, the flow of the processing goes on to a step SS9. If a release operation has not been carried out, on the other hand, the flow of the processing goes back to the step SS7.

At the step SS9, the display element appearing at the end position of the drag operation is changed to a display element indicating the end of the drag operation. The end position of the drag operation is a position at which the user carries out the release operation. That is to say, as shown in FIG. 9C, when the user separates the finger, the stylus or the like away from the operation face of the touch panel ill, the operation to separate the finger, the stylus or the like away from the operation face of the touch panel 111 is recognized as an operation to end the drag operation. As a result, as shown in FIG. 9D, a specific display element 25 appears on the screen for a predetermined period of time. In this example, the display element 25 is a double-circle mark. It is to be noted that the display element 21 appearing at the start position of the drag operation, the locus 24 and the display element 25 appearing at the end position of the drag operation are each sustained for a predetermined period of time relative to the start time of the drag operation. In addition, as a method of changing a display element, it is possible to adopt a method such as a technique to change an attribute of the display element or a technique to show a display element as a blinking display for distinguishing the element from the other. Besides the color and shape of the display element as is the case with the examples described above, another example of the attribute of the display element is the size of the element.

As described above, when an input entered via the touch panel 111 or an operation carried out on the touch panel 111 is recognized as a drag operation, during the drag operation, the display element is changed to a display element specially provided for the drag operation. Then, when the drag operation is ended, the display element specially provided for the drag operation is further changed to a display element indicating the end of the drag operation. In addition, it is desirable to show a display element appearing at the start point of the drag operation and the locus of the drag movement on the screen during a predetermined period of time starting from the end point of the drag operation.

It is to be noted that, by changing the display element to a special one proof against a parallax error occurring in the course of the drag operation, it is possible to avoid a damage caused by such a parallax error. An example of the special display element proof against a parallax error is the icon of a mouse pointer.

In addition, when a release operation is carried out in the course of a drag operation to end the drag operation, the display element is changed to a display element indicating the end of the drag operation and the display element indicating the end of the drag operation is kept on the screen for a predetermined period of time. By carrying out this processing, information can be fed back explicitly to the user as information indicating whether or not the drag operation has been carried out as intended by the user or whether or not the drag operation has been inadvertently ended at a point not intended by the user.

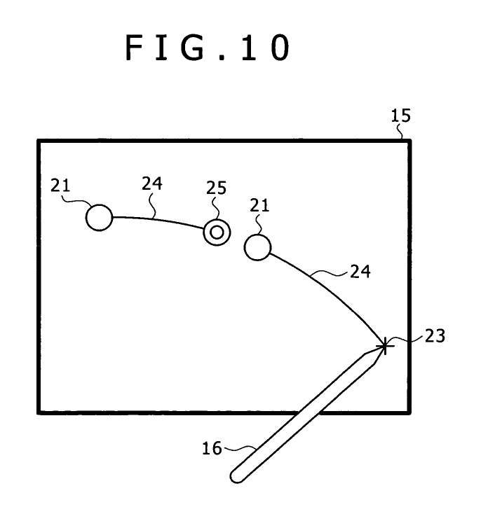

If the user is not aware of the fact that a drag operation has been ended inadvertently on a temporary basis in the course of an operation such as an operation to enter a hand-written character and the user then resumes the drag operation, for example, a discontinuity is generated at a contact point on the operation face, that is, the locus of the drag operation is broken up. In this case, the user is of course incapable of carrying out the input operation correctly and there is no way for the user to know why the input operation cannot be done correctly. Thus, a disturbing problem is raised. If a release operation is carried out in the course of a drag operation as described above, however, a display element 25 appearing at the end point of the drag operation and a past locus 24 between the start and end points of the drag operation are explicitly displayed. In addition, a display element 21 appearing at the start point of the continuation drag operation is also displayed explicitly. As a result, displays appear on the screen as shown in FIG. 10. As shown in the figure, an inadvertent suspension of the drag operation is visually presented in an explicit manner to the user as a broken point of the drag operation. That is to say, the user is capable of knowing that an inadvertent operation mistake has been made and knowing the reason why the mistake has been made.

The configuration described above offers the following merits.

It is possible to implement a feature of explicitly feeding back a result of an operation carried out by the user to enter an input via the touch panel to the user.

A result of an operation carried out unconsciously by the user to inadvertently enter an input can be known immediately.

When the user carries out a double-tap operation deliberately, the user is capable of immediately verifying whether the operation has been actually carried out in a correct manner.

It is possible to avoid a damage caused by a parallax error occurring in the course of a drag operation.

It is possible to verify whether the drag operation has been carried out as intended by the user or whether the drag operation has been inadvertently ended at a point not intended by the user.

What is claimed is:

1. An information-processing apparatus comprising:
a coordinate input unit for detecting coordinates of a position specified in an operation carried out by the user on said coordinate input unit; and
a display section in which said coordinate input unit is integrated,
wherein said information-processing apparatus gives said user a notice according to the type of said operation carried out by said user on said coordinate input unit as a notice for verifying the state of said operation, verifying a result of said operation or preventing an incorrect operation.

2. The information-processing apparatus according to claim 1 wherein, as said notice, a display detectable by the visual sense is shown to the user in accordance with said operation carried out by the user on said coordinate input unit.

3. The information-processing apparatus according to claim 1, said information-processing apparatus further having an audio output section for outputting a sound according to said operation carried out by the user on said coordinate input unit as said notice.

4. The information-processing apparatus according to claim 1, said information-processing apparatus further having a vibration generation section for generating vibration according to said operation carried out by the user on said coordinate input unit as said notice.

5. A program to be executed by an information-processing apparatus comprising:
a coordinate input unit for detecting coordinates of a position specified by an operation carried out by the user on said coordinate input unit; and
a display section in which said coordinate input unit is integrated,
wherein said program includes a step of giving the user a notice according to the type of said operation carried out by the user on said coordinate input unit as a notice for verifying the state of said operation, verifying a result of said operation or preventing an incorrect operation.

6. The program to be executed by the information-processing apparatus according to claim 5, said program for execution by said information-processing apparatus further having the steps of:
detecting the fact that said operation has been carried out on said coordinate input unit; and
issuing a command to output a display detectable by the visual sense as a display according to the number of times contact with said coordinate input unit has been made in said operation or according to a state of sustaining said contact or a command to modify said display.

7. The program to be executed by the information-processing apparatus according to claim 5, said program for execution by said information-processing apparatus further having the steps of:
detecting the fact that said operation has been carried out on said coordinate input unit; and
issuing a command to output a sound according to the number of times contact with said coordinate input unit has been made in said operation or according to a state of sustaining said contact or a command to modify said sound.

8. The program to be executed by the information-processing apparatus according to claim 5, said program for execution by said information-processing apparatus further having the steps of:
detecting the fact that said operation has been carried out on said coordinate input unit; and
issuing a command to generate vibration according to the number of times contact with said coordinate input unit has been made in said operation or according to a state of sustaining said contact or a command to modify said vibration.
